(19) United States
(12) Patent Application Publication
(10) Pub. No.: US 2026/0360255 A1
(43) Pub. Date: Nov. 12, 2026

(54) SYSTEMS AND METHODS FOR COOPERATIVE PERCEPTION, MAPPING, AND LOCALIZATION

(71) Applicant: Toyota Motor Engineering & Manufacturing North America, Inc., Plano, TX (US)

(72) Inventors: Qi Chen, San Jose, CA (US); Deyuan Qu, Sunnyvale, CA (US); Sergei Avedisov, Redwood City, CA (US); Akila Ganlath, Fremont, CA (US); Onur Altintas, Sunnyvale, CA (US); Shatadal Mishra, Santa Clara, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/203,956

(22) Filed: May 9, 2025

(51) Int. Cl. G08G 1/16; G01S 17/89; G01S 17/931; G08G 1/0967; H04W 4/46

(52) U.S. Cl. CPC G08G 1/161; G01S 17/89; G01S 17/931; G08G 1/096725; G08G 1/096791; H04W 4/46

(57) ABSTRACT

Systems and methods for cooperative perception, mapping, and localization, such as those used by connected vehicles, are provided. A first vehicle and a second vehicle may each collect sensor data about a shared environment in which the first and second vehicles are located, process using a computational model on-board each of the first and second vehicle the sensor data to identify features and/or key points based upon the sensor data, and transmit those features and/or key points to the other vehicle so that the other vehicle may perform maneuvers and/or otherwise act upon object data which may not be visible to sensors of the respective vehicle alone.

### TECHNICAL FIELD

The present specification relates to systems and methods for cooperative perception, mapping, and localization, such as that used by connected vehicles, and more particularly, use of a common computational model to identify features and/or key points within sensor data, mapping the same relative to a global coordinate frame, and sharing the features and/or key points among one or more other vehicles so that each vehicle may conduct decision making with a more comprehensive dataset.

### BACKGROUND

Cooperative perception refers to the ability of multiple entities, such as vehicles, and/or infrastructure systems to share sensor data and environmental insights to enhance situational awareness and decision-making. For any given entity, the range, scope, and/or field of view of one or more sensors may be limited such that certain objects or the like may not be visible to that entity for use in decision making. In the case of autonomous driving, this may be an inability to see an incoming vehicle, pedestrian, road hazard, or the like.

However, and especially in autonomous or semi-autonomous vehicle contexts, the amount of data generated by the sensors of these entities can be significant, such that normal network or communication interfaces may lack sufficient bandwidth to exchange a necessary quantity of information between entities on a time scale practicable for decision making. Furthermore, limited computing resources available in distributed entities such as multiple vehicles on a road can increase the time needed to process such quantities of data, further limiting the usefulness of cooperative perception in these time-sensitive contexts.

Accordingly, a need exists for providing systems and/or methods that can facilitate faster, yet still accurate, exchange of localized information between connected entities.

### SUMMARY

The present disclosure provides systems and methods for the cooperative perception, mapping, and/or localization of information between connected entities, such as connected vehicles, to provide data on a time scale that is practicable for decision making given prevailing contexts.

In one embodiment, a method for cooperative perception, mapping, and localization provided. The method includes obtaining sensor data pertaining to an environment of a first vehicle, processing the sensor data using a computational model that identifies features and/or key points within the sensor data, optionally defining the features and/or key points relative to a reference frame, and transmitting the features and/or key points to a second vehicle. The method further relates to receiving similar data at the first vehicle and autonomously controlling the first vehicle to execute a maneuver that is based at least in part on features and/or key points received from a second vehicle.

In another embodiment, a system for cooperative perception, mapping, and localization provided. The system includes a vehicle that comprises one or more sensors and at least one process and that is configured to obtain sensor data pertaining to an environment of a first vehicle, process the sensor data using a computational model that identifies features and/or key points within the sensor data, optionally define the features and/or key points relative to a reference frame, and transmit the features and/or key points to a second vehicle. The system may further be configured to receive similar data at the first vehicle and autonomously control the first vehicle to execute a maneuver that is based at least in part on features and/or key points received from a second vehicle.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a system for cooperative perception, mapping, and/or localization, according to one or more embodiments shown and described herein;

FIG. 2A schematically depicts an exemplary scenario in which cooperative perception, mapping, and/or localization may be utilized, emphasizing the field of view of a first vehicle;

FIG. 2B schematically depicts an exemplary scenario in which cooperative perception, mapping, and/or localization may be utilized, emphasizing the field of view of a second vehicle;

FIG. 3 shows a block diagram of an exemplary pillar-based feature and/or key point extraction method; and

FIG. 4 depicts an overall process for cooperative perception, mapping, and/or localization between connected entities, according to one or more embodiments shown and described herein.

### DETAILED DESCRIPTION

The embodiments disclosed herein include systems and methods for cooperative perception, mapping, and/or localization between connected entities.

As used herein, “entity” may refer to any device and/or subcomponent which is provided with one or more sensing means for collecting data and one or more communication means for conveying the data and/or some derivation thereof to another device or subcomponent. While the present disclosure makes extensive use of automotive contexts as examples to explain the nature and structure of those systems and methods described herein, it is contemplated that such systems and methods are not so limited except where explicitly stated otherwise and may provide benefits in other cooperative contexts, such as robotics and/or industrial automation, drones and/or unmanned systems, traffic management, healthcare, and the like, without limit.

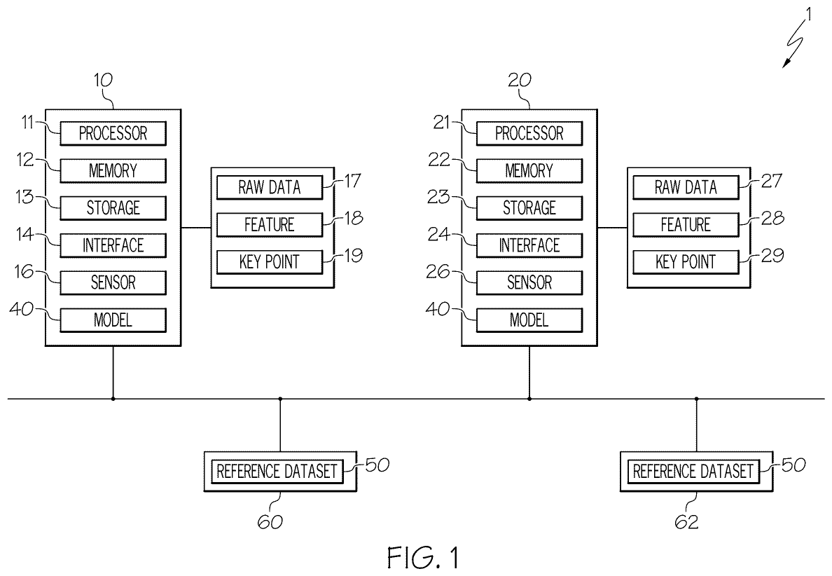

Referring now to FIG. 1, an exemplary system 1 for cooperative perception, mapping, and/or localization between connected entities is schematically shown.

A first entity, or first vehicle 10, and a second entity, or a second vehicle 20, are provided. The first vehicle 10 may be provided with one or more processors 11, memory units 12, storage units 13, interfaces 14 (e.g., user interfaces, network interfaces, vehicle to vehicle or V2V interfaces, vehicle to everything or V2X interfaces, antennas, transmitters, and the like), and sensors 16. Similarly, the second vehicle 20 may be provided with one or more processors 21, memory units 22, storage units 23, interfaces 24, and sensors 26.

The term “vehicle,” as used herein, may refer to any car, truck, motorcycle, van, scooter, robot, mobility unit, watercraft, aircraft, or the like, without limit, used in the course of personal, recreational, or commercial transportation. The vehicle may be manually driven by an occupant, semi-autonomously driven, or fully autonomous, at any level of automation, such as that defined by the Society of Automotive Engineers (SA E) J 31016 standard levels 0 through 5.

The term(s) “processor(s),” as used herein, may refer to any computational device capable of executing instructions, performing logical operations, and/or processing data and may include, but are not limited to, general-purpose central processing units (CPUs), field-programmable gate arrays (FPGAs), application-specific integrated circuits (ASICs), and other processing units such as graphics processing units (GPUs), neural processing units (NPUs), and/or digital signal processors (DSPs). The processor may be implemented as a single processing core, a multi-core architecture, and/or a distributed network of processing elements. The processors may be integrated within a system-on-chip (SoC) or as a discrete component interfaced with other system elements.

One or more of the memory units 12, 22 and the storage devices 13, 23 may, singly jointly, or in any combination thereof, comprise and/or otherwise embody a non-transitory computer-readable storage medium capable of storing instructions that, when executed by one or more of processors, such as processors 11, 21, cause the processors and/or a device and/or subcomponent controlled thereby to carry out some form, function, process, or the like relevant to those systems and methods disclosed herein.

Interfaces 14, 24 may include any combination of antennas, receivers, transceivers, transmitters, sensors, and the like for exchanging data between entities. Examples of interfaces 14, 24 may include any combination of network interfaces, wireless LAN and/or WiFi, Bluetooth, dedicated short-range communications (DSRC), cellular network interfaces (e.g., 3G, 4G, 5G, LTE, GSM, CDMA, MTS), microwave networks, ultra-wideband (UWB) communication, LIDAR-based communication, Bluetooth, and the like, without limit.

The various entities may communicate with one another through interfaces 14, 24 directly and/or may communicate with one another indirectly, such as through a server 60 and/or other edge computing device 62 (e.g., mobile phone, tablet, smart devices, infrastructure devices and/or traffic control devices, drones, routers and/or network gateways, and the like, without limit. Communications between entities may occur, for example, over the Internet, a cellular data network, and/or a local network, without limit.

Sensors 16, 26 may include cameras or visual light sensors, infrared/ultraviolet cameras/sensors, radar emitters/detectors, ultrasonic emitters/detectors, LIDAR scanners, microwave emitters/detectors, time-of-flight scanners/detectors, and any other similar or comparable scanner or detector which is capable of taking measurements of an environment at a distance. The one or more sensors 16, 26 may also include devices such as GPS sensors or sensors of other satellite-position based technologies, clocks/timers, and the like necessary to facilitate operation of the above.

Sensors 16, 26 may be configured to and/or otherwise operable to generate one or more sensor datasets 17, 27 of an environment surrounding the first and/or second entities. The one or more datasets 17, 27 may, for example, include point clouds or point cloud data, depth maps and/or depth images, two-or three-dimensional mesh data and/or structured point clouds, time of flight data, voxel and/or volumetric data, spectra, images, videos, and the like, without limitation.

It may further be appreciated that the first and second entities, or first vehicle 10 and second vehicle 20, may use the same types of sensors 16, 26 (e.g., both may use LIDAR sensors), or the first and second entities may use different types of sensors (e.g., the first vehicle 10 uses LIDAR while the second vehicle 20 uses a camera system).

The sensor datasets 17, 27 may be processed by one or more computational models 40 to distill the datasets into and/or extract from the datasets one or more features 18, 28 and/or key points 19, 29.

Computational models 40 may include one or more mathematical models (e.g., deterministic models, linear/nonlinear models, agent-based models), algorithmic models, machine learning models (e.g., supervised/unsupervised learning models, reinforcement learning models), neural networks (e.g., convolutional neural networks, transformers), deep learning models, probabilistic models, and/or any combination thereof. Computational models 40 may, additionally or alternatively, include student models and/or distilled models which have been trained to mimic the behavior and/or outputs of a larger and/or complex model. Such distilled models may generate comparable results faster and/or with fewer computational resources. In any case, the computational model(s) 40 may be configured with certain rules, parameters, thresholds, weights, biases, and/or the like for identifying features 18, 28 and/or key points 19, 29 and/or the computational model(s) 40 may be trained using one or more training datasets to recognize from the sensor datasets 17, 27 those features 18, 28 and/or key points 19, 29 sought to be extracted.

Computational models 40 may be stored on any of the storage devices 13, 23 and/or memory units 12, 22 and/or may be executed by any of the processors 11, 21.

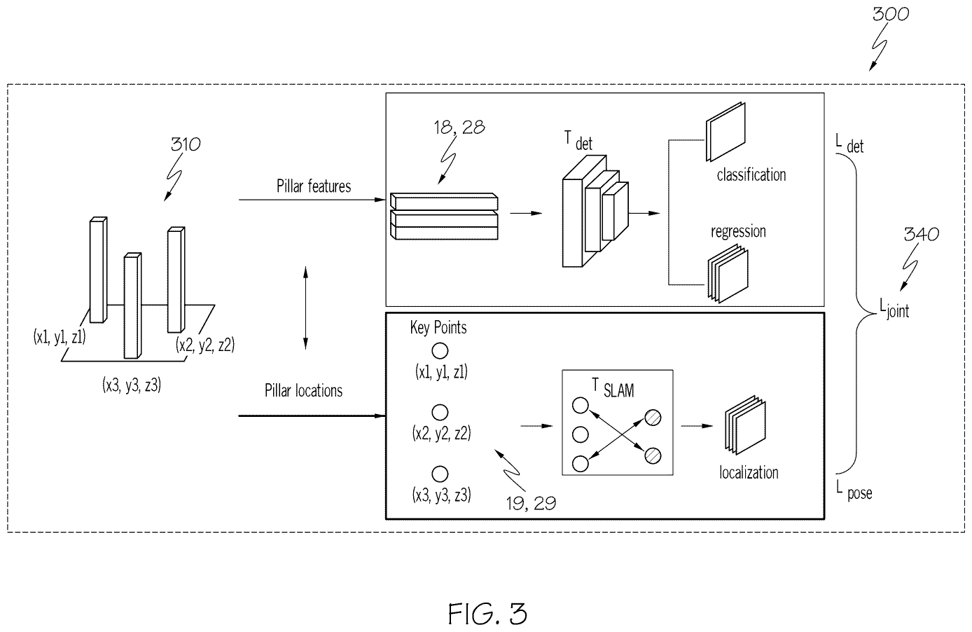

For example, as represented in FIG. 3 and with continued reference to FIG. 1, the computational model(s) 40 may utilize a pillar-based approach 300 to process the datasets 17, 27 collected by sensors 16, 26. The point clouds and/or domains represented by the datasets 17, 27 may be broken down into grids and any points and/or relevant readings within these grids grouped to form pillars 310. In essence, the pillar-based approach reduces a three-dimensional problem into a two-dimensional problem which is well suited to processing by such algorithms and/or using limited computational resources. The pillars 310 may then be processed by a convolutional neural network or other similar machine-learning based algorithm to process the pillars and perform feature extraction to identify features 18, 28. Additionally and/or alternatively, the position of these pillars may be further processed such that the location of the pillars may, in turn, inform the location of corresponding key points 19, 29. Losses among any of the features 18, 28, key points 19, 29, and/or joint losses of the same may then be minimized until a certain confidence level is reached 340.

It may be appreciated that other methods known to a person having ordinary skill in the art may also be used in place of and/or in addition to this pillar-based approach.

Features 18, 28 may include macro-level properties and/or characteristics of an object, image, or data such as a bounding box, size, quantity, edge, corner, texture, and/or region of interest. For example, features of a vehicle may include a bounding box which encloses said vehicle, an outline of the vehicle, headlights of the vehicle, a distance between headlights, wheels, a front and/or rear bumper, a line or curve corresponding to a front and/or rear bumper, points corresponding to a front and/or rear end of said vehicle, and the like, without limit. Features of a tree may include, for example, a bounding box of said tree, a bounding box at vehicle-level of said tree which neglects those portions of the tree which have no impact on vehicle navigation, a line corresponding to a main trunk line of said tree, a circumference of a trunk of said tree, a point which locates said tree, and the like, without limit.

Identification of features 18, 28 may also include a simultaneous object identification step, and/or a subsequent object identification step may be performed on the identified features 18, 28 to determine what objects within the sensor data 17, 27 the features 18, 28 represent.

Key points 19, 29 are derivable from features 18, 28 and represent notable points within the datasets 17, 27. Key points 19, 29 may include identifiable points and/or positional landmarks that may be robust to transformations (e.g., rotation, scaling, and/or changes in perception) and/or may otherwise remain stable between successive datasets 17, 27. For example, key points may include the location of headlights and/or points corresponding to a bumper of a vehicle, points corresponding to immovable infrastructure such as buildings, telephone and/or utility poles, points corresponding to a bounding box and/or points corresponding to a location of such a bounding box and/or object enclosed thereby, and the like, without limit. In other contexts, the tip of a person's nose, a trunk line of a tree, or other comparable positional landmarks may serve as key points.

When a vehicle 10, 20 scans its surroundings with the one or more sensors 16, 26, the resulting sensor datasets 17, 27 are typically represented from a perspective of the vehicle 10, 20 or in a coordinate frame unique to the vehicle 10, 20. That is, a location of the first vehicle 10 may serve as the point of origin (e.g. [x=0, y=0, z=0]) of the first sensor dataset 17, while a location of the second vehicle 20 may serve as the point of origin of the second sensor dataset 27. In order to cooperatively use both sensor datasets 17, 27 on any given vehicle 10, 20, however, the relationship between these two points of origins must be known. In other words, these two datasets must be aligned or registered so that the first sensor dataset 17 may accurately extend the second sensor dataset 27, or vice versa.

Typically, such an alignment may be performed by using GPS data to locate each of the first and second vehicles 10, 20 within a global coordinate frame. However, because the error in GPS geolocation is often significantly larger than the resolution of the sensor datasets 17, 27, it may be difficult to obtain accurate alignment between the datasets 17, 27.

To overcome this challenge, one or more of the key points 19, 29, may be used to positionally register one or more datasets 17, 27 with one another so that objects may be represented in a common coordinate frame.

For example, in a scenario in which the first dataset 17 overlaps at least partially with the second dataset 27, key points within the region of overlap may be used to register and/or align the datasets 17, 27 with one another. For example, because it may be safe to assume that a trunk line of a tree within this overlap region won't materially move or shift in time or perspective between two datasets, one or more key points representing this trunk line may be identified in each of the first dataset 17 and the second dataset 27 and the resulting relative position, orientation, and the like of the first dataset 17 and second dataset 27 may be accurately determined. From this, a relationship between the coordinate frame of the first dataset 17 and the coordinate frame of the second dataset 27 may be established. With this relationship, the second vehicle 20 may receive the first dataset 17 from the first vehicle and seamlessly extend its perception of an environment. Any number of key points 19, 29 may be used to perform a registration (e.g., key points representing the tree, a corner of a building, and a manhole cover in the street may, in any combination, used to register the datasets with one another).

As another example, in a scenario in which the first dataset 17 does not overlap with the second dataset 27, a reference dataset 50 may be provided such that the first dataset 17 and the second dataset 27 may each be independently registered with the reference dataset 50 by identifying key points common between the first dataset 17 and the reference dataset 50 and between the second dataset 27 and the reference dataset 50. When a relationship between the first dataset 17 and the reference dataset 50 is determined, and a relationship between the second dataset 27 and the reference dataset 50 is determined, a relationship between the first dataset 17 and the second dataset 27 may be determined even though there is no overlap between the first and second datasets.

One or more reference datasets 50 may be provided to any of the first and/or second entities from any of the server 60, edge computing device 62, or other similar device. The reference dataset 50 may reflect, for example, a global coordinate system relevant and/or relative to those datasets 17, 27 collected by the first and/or second entities.

It may be appreciated that cognition of what object a given key point represents is not a prerequisite for performing registration, but only used here for explanatory purposes. That is to say, an object identification and/or detection step need not be performed prior to registration of two or more datasets. There may certainly be instances in which the system does not yet know that a series of points that are being used as key points represent the trunk of a tree, and yet the shape/relative position/etc. of these points may themselves be sufficiently unique to identify such a shape/relative position/etc. in each dataset and to perform registration. Recognition that these points define the trunk of a tree may later occur after the datasets have been registered with one another.

It may be further appreciated that the use of two datasets 17, 27 and/or the inclusion of a third reference dataset 50 here is likewise exemplary only. Any number of datasets from any number of vehicles, infrastructure devices (e.g., traffic cameras, edge devices and/or sensors), entities, and the like may be registered with one another in this manner.

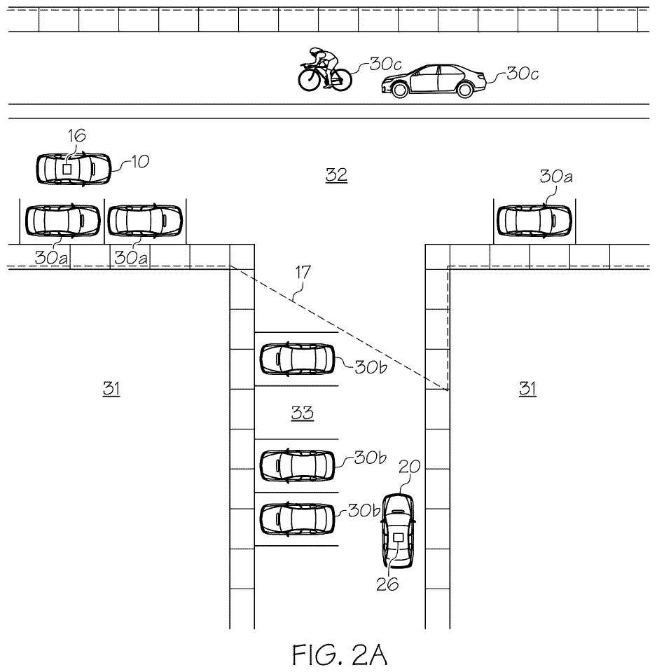

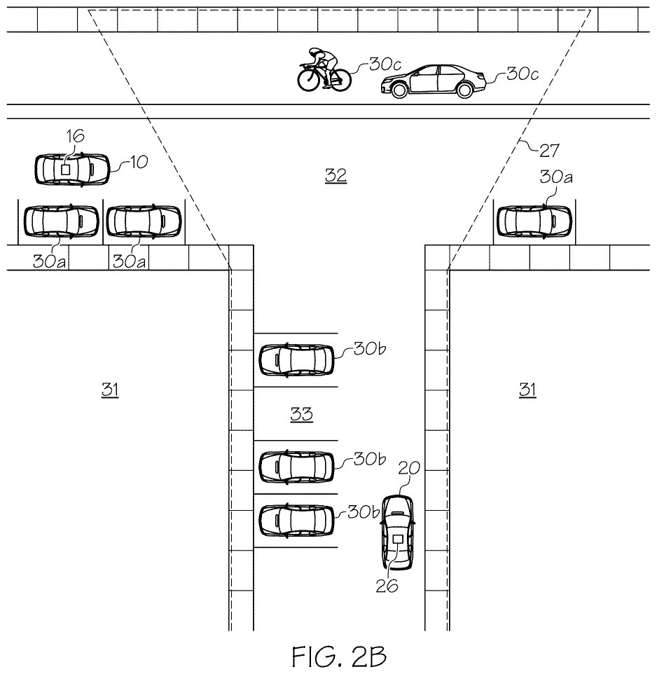

Turning now to FIGS. 2a-2b, with continued reference to FIG. 1, an exemplary scenario in which a first vehicle 10 and a second vehicle 20 are engaging in cooperative perception, mapping, and/or localization is shown. Both scenes are identical except that FIG. 2A emphasizes the field of view 17 of the first vehicle 10, whereas FIG. 2B emphasizes the field of view 27 of the second vehicle 20.

Within the scene of FIGS. 2A-2B, both the first vehicle 10 and the second vehicle 20 are approaching an intersection 32. However, because of obstructions 31, such as buildings, trees, signs, other vehicles, landscaping, hills, and/or the like that may block the field of view 17, 27 of the sensors 16, 26 of any of the first vehicle 10 and/or the second vehicle 20, not all of those objects present within the scene are visible to both the first vehicle 10 vehicle or the second vehicle 20.

For example, the first vehicle 10 may be equipped with a sensor 16 embodied as a LiDAR sensor that, due to the presence of obstructions 31, can only “see” and/or otherwise collect a datasets 17 that include objects 30a and 30c-but not objects 30b. Similarly, second vehicle 10 may be equipped with a sensor 26 embodied as a camera and a LIDAR sensor that, due to the presence of obstructions 31, can only “see” and/or otherwise collect datasets 27 that include objects 30b and 30c-but not objects 30a. It may further be apparent that the first vehicle 10 and the second vehicle 20 may therefore both “see” and/or otherwise collect datasets 17, 27 that include objects 30c.

For the purposes of navigation and/or some other operational need, it may be beneficial to provide the second vehicle information about objects 30a and the first vehicle information about objects 30b so that appropriate controls and/or decisions may be made, even though the sensors 16, 26 do not detect these objects.

Objects 30 may be any object whose information is desirable to be known for the operation and/or decision making of any of the first and/or second entities. In the exemplary vehicle context of FIGS. 2A-2B, objects may include other vehicles, pedestrians, road hazards (e.g., potholes, debris, spills), emergency vehicles, stopped/stalled vehicles, street signs, other intersections and/or roads, and the like, without limit.

However, because the datasets 17, 27 collected by the sensors 16, 26 may be quite large—such as the case may be for LiDAR sensors and the resulting point clouds and/or depth maps—and because the transmission bandwidth of interfaces 14, 24 may be limited, it may be too late to act upon information contained within the datasets 17, 27 by the time these datasets 17, 27 are exchanged between the first vehicle and the second vehicle. In some cases, simply increasing this bandwidth is either impossible or impractical from a cost standpoint.

To overcome these challenges, each of the first vehicle 10 and the second vehicle 20 are provided with a computer model which processes the datasets 17, 27 on-board the first vehicle 10 and the second vehicle 20, respectively. As noted above, the computer model 40 may be a distillation of a larger computer model 40, such that the computer model 40 may be operated by limited hardware of the first vehicle 10 and/or the second vehicle. As the datasets 17, 27 are processed, one or more key points 19, 29, and/or features 18, 28 may be identified from the datasets 17, 27. In some embodiments, it may be preferable such that the computer models 40 of the first vehicle 10 and the second vehicle 20 are identical. In other embodiments, it may preferable to use different computer models 40.

Additionally, the first vehicle 10 and/or the second vehicle 20 may be supplied with a reference dataset 50 which serves as a common reference frame for identifying objects in the vicinity of any of the first vehicle 10 and/or the second vehicle. Each of the first vehicle 10 and/or the second vehicle 20 may convert their respective datasets 17, 27 to the common reference frame of the reference dataset 50 before and/or after processing of the datasets 17, 27 by the computational model 40.

In either case, features 18, 28 and/or key points 19, 29 describing objects in the scene are generated and may then be exchanged between the first vehicle 10 and/or the second vehicle 20. Features 18, 28 and/or key points 19, 29 may be exchanged as-is or may further be combined before exchange. Because features 18, 28 and/or key points 19, 29 are significantly simpler than the datasets 17, 27 from which they originated, significantly less information needs to be exchanged between the first vehicle 10 and the second vehicle 20 through interfaces 14, 24. As a result, no change to the interface 14, 24 hardware is needed.

Furthermore, the conversion to the common reference frame of the reference dataset 50 ensures that any coordinate data provided to the first vehicle 10 from the second vehicle 20 is immediately comprehensible, and vice versa.

In some embodiments, the amount of data exchanged between vehicles 10, 20 and/or edge devices 62 is dependent on the amount of bandwidth available. If the bandwidth is sufficient to exchange the full original datasets 17, 27, point clouds, and/or the like, then these full data packages may be exchanged without further refinement. If, however, the bandwidth is insufficient to exchange the full original datasets 17, 27, point clouds, and/or the like, the exchange of data may be delayed to later steps in the process (e.g., after feature detection, and/or after key point detection, and/or after object recognition, and the like) at which the amount of data to be exchanged is reduced.

Adaptation in response to the available bandwidth may be conducted in real time, such that the first vehicle 10 or entity may transmit to the second 20 vehicle or entity full, original datasets until such a time those communication links with sufficient throughput for such an exchange are disrupted, blocked, or otherwise interfered with, at which point the first vehicle 10 or entity may automatically step down to lower throughput communication links and instead transmit smaller data packages to the second vehicle 20 or entity. Likewise, the second vehicle 20 or entity may be configured to automatically adjust its processes based on the type and/or amount of data it is receiving from the first vehicle 10 or entity.

Once the second dataset 27, second features 28, and/or second key points 29 are received at the first vehicle 10, the first vehicle 10 may be controlled based upon the second dataset 27, second features 28, and/or second key points 29. For example, the first vehicle 10 may discern from the second dataset 27, second features 28 and/or second key points 29 sent by the second vehicle 20 that a parking spot 33 exists. The first vehicle 10 may then be controlled to park in the observed parking space 33. In another example, the first vehicle 10 may be controlled to perform object avoidance if the second dataset 27, second features 28 and/or second key points 29 indicate that there is an upcoming object which the first sensors 16 of the first vehicle 10 are unable to see. In another example, the specific path taken by the first vehicle 10 as part of an evasive maneuver to avoid hitting a stopped vehicle, pedestrian, or the like may be take into account data contained in or represented by the second dataset 27, second features 28 and/or second key points 28.

Of course, it is contemplated that the reverse may be true, with second vehicle 20 being controlled based upon the first dataset 17, first features 18, and/or first key points 19 received from the first vehicle 10.

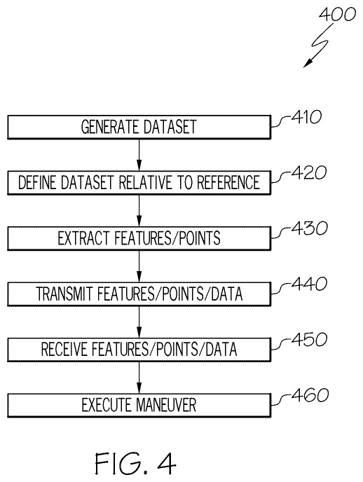

Turning now to FIG. 4, with continued reference to FIG. 1, a flow chart of an exemplary method 400 consistent with those disclosures herein is shown.

In step 410, the first vehicle 10 generates using one or more first sensors 16 a first sensor dataset 17 which describes at least a portion of an environment around the first vehicle 10.

In step 420, the first vehicle 10 may be originally provided with or otherwise receive a reference dataset 50 describing the environment around the first vehicle to a greater extent than what is observable by the sensors 16 of the first vehicle 10. The first vehicle may then define the first dataset 17 relative to the reference dataset 50 or may wait until after step 430, at which point the first vehicle 10 may define any first features 18 and/or first key points 19 relative to the reference dataset 50.

In some embodiments, the first vehicle 10 may receive a second sensor dataset 27 from a second vehicle 20 and define the first sensor dataset 17 relative to the second sensor dataset 18.

In step 430, the computational model 40 is used by the first vehicle 10 to extract at least one first feature 18 and/or at least one first key point 19 from the first sensor dataset 17. In some embodiments, this step may include identifying the at least one first key point 19 from or otherwise based upon any first features 18 which are found within the first dataset 17.

In step 440, one or more of the first dataset 17, first key feature 18 and/or the at least one first key point 19 are transmitted to the second vehicle 20. Transmission may be direct (e.g., V2V communication protocols) or indirect (e.g., through a server 60 and/or edge computing device 62).

Substantially simultaneously to steps 410-440 and/or within a comparable time frame, the second vehicle 20 may likewise execute steps 410-430 in order to identify one or more second feature 28 and/or second key points 29 within a second sensor dataset 27 captured by one or more second sensors 26 of the second vehicle 20 and transmit the same to the first vehicle 10.

In step 450, the first vehicle 10 receives from the second vehicle 20 one or more of the second dataset 27, second features 28, and/or second key points 29.

In step 460, the first vehicle 10 executes a maneuver that is based at least in part upon the one or more second dataset 27, second features 28, and/or second key points 29 received from the first vehicle. The maneuver may involve steering, braking, and/or otherwise navigating the vehicle consistent with a navigation or autonomous vehicle stack or the like. These maneuvers may be executed to find parking and/or otherwise park the car, avoid road hazards, and the like.

As it may be the case that the second dataset 27, second features 28, and/or second key points 29 identified by the second vehicle 20 may not be visible to the first vehicle 10, it may thus be the case that the first vehicle is capable of executing maneuvers and/or operating its autonomous driving stack in a manner that was not previously possible by extending the data upon which the first vehicle 10 may make decisions using information received from the second vehicle 20.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method for evaluating an environment around a first vehicle, the method comprising:
generating, at the first vehicle, a first sensor dataset based on sensor readings taken by one or more sensors of the first vehicle of the environment around the first vehicle;
extracting at least one first feature from the first sensor dataset using a computational model;
identifying at least one first key point associated with each of the at least one first feature;
transmitting one or more of the at least one first key point and the at least one first feature to a second vehicle;
receiving, by the first vehicle, one or more of at least one second key point and at least one second feature identified by the second vehicle; and
autonomously controlling the first vehicle to execute a maneuver based on one or more of the at least one second key point and the at least one second feature.

2.-3. (canceled)

4. The method according to claim 1, further comprising:
receiving, at the first vehicle, a reference dataset which describes at least the environment around the first vehicle; and
defining the at least one first feature and/or the at least one first key point relative to the reference dataset.

5. The method according to claim 4, wherein the at least one second feature and/or the at least one second key point are, before being received by the first vehicle, defined relative to the reference dataset.

6. The method according to claim 4, wherein the reference dataset is defined according to a global coordinate frame that is independent of any local coordinate frames of the first and second vehicles.

7. The method according to claim 1, wherein the one or more of the at least one first key point and the at least one first feature is transmitted directly from the first vehicle to the second vehicle using vehicle-to-vehicle communication.

8. The method according to claim 1, wherein the one or more of the at least one first key point and the at least one first feature is transmitted indirectly from the first vehicle to the second vehicle via at least one of a server and an edge computing device.

9. The method according to claim 1, wherein the one or more sensors of the first vehicle comprise a LiDAR device.

10. The method according to claim 1, wherein one or more of the at least one second feature and/or the at least one second key point are not within a field of view of the one or more sensors of the first vehicle.

11. A system for evaluating an environment around a first vehicle, comprising:
a first vehicle that includes a processor and one or more sensors, wherein the first vehicle is configured to:
generate, at the first vehicle, a first sensor dataset based on sensor readings taken by the one or more sensors of the first vehicle of the environment around the first vehicle;
extract at least one first feature from the first sensor dataset using a computational model;
identify at least one first key point associated with each of the at least one first feature;
transmit one or more of the at least one first key point and the at least one first feature to a second vehicle;
receive, from the second vehicle, one or more of at least one second key point and at least one second feature identified by the second vehicle; and
autonomously control the first vehicle to execute a maneuver based on one or more of the at least one second key point and the at least one second feature.

12.-13. (canceled)

14. The system according to claim 11, wherein the first vehicle is further configured to:
receive, at the first vehicle, a reference dataset which describes at least the environment around the first vehicle; and
define the at least one first feature and/or the at least one first key point relative to the reference dataset.

15. The system according to claim 14, wherein the at least one second feature and/or the at least one second key point are, before being received by the first vehicle, defined relative to the reference dataset.

16. The system according to claim 14, wherein the reference dataset is defined according to a global coordinate frame that is independent of any local coordinate frames of the first and second vehicles.

17. The system according to claim 11, wherein the one or more of the at least one first key point and the at least one first feature is transmitted directly from the first vehicle to the second vehicle using vehicle-to-vehicle communication.

18. The system according to claim 11, wherein the one or more of the at least one first key point and the at least one first feature is transmitted indirectly from the first vehicle to the second vehicle via at least one of a server and an edge computing device.

19. The system according to claim 11, wherein the one or more sensors of the first vehicle comprise a LiDAR device.

20. The system according to claim 11, wherein one or more of the at least one second feature and/or the at least one second key point are not within a field of view of the one or more sensors of the first vehicle.
